(19) United States
(12) Patent Application Publication
(10) Pub. No.: US 2026/0125226 A1
(43) Pub. Date: May 7, 2026

(54) Method for Loading Transport Units with Packages

(71) Applicant: Deutsche Post AG, Bonn (DE)

(72) Inventors: Frank Langer, Troisdorf (DE); Saira Pathan, Köln (DE)

(21) Appl. No.: 19/381,033

(22) Filed: Nov. 6, 2025

(30) Foreign Application Priority Data
Nov. 7, 2024 (DE) 10 2024 132 422.8

(51) Int. Cl. B65G 47/48

(52) U.S. Cl. CPC B65G 47/48; B65G 2201/0235; B65G 2203/041

(57) ABSTRACT

A method for loading at least one transport unit with packages is described and illustrated. In order to prevent damage to packages as a result of loading the packages into a transport unit, it is provided that the packages are scanned one after another with an optical scanner, that at least one stability parameter for each package is determined based on the images of the optical scanner by an evaluation unit, that the evaluation unit assigns a stability score to each package based on the at least one stability parameter, and that the packages are loaded into different locations in the at least one transport unit depending on the respective stability scores.

### CROSS-REFERENCE TO RELATED APPLICATION

This application claims priority to German Patent Application No. 10 2024 132 422.8 filed Nov. 7, 2024, the disclosure of which is hereby incorporated by reference in its entirety.

### BACKGROUND OF THE INVENTION

### Field of the Invention

The invention relates to a method for loading at least one transport unit with packages.

### Description of Related Art

Methods for loading transport units with packages are known from various applications, wherein the transport units can be loaded manually or using a robot. If the packages have random sizes and weights and are loaded into the transport units in a random order, the cargo space provided by the transport units is not always fully utilized. In addition, packages may be damaged by other packages loaded into the same transport units subsequently.

This is particularly problematic in connection with methods for redistributing packages in sorting stations, which are known in various designs and in which the packages are loaded into many mostly similar transport units after sorting in the sorting station. The packages can first be delivered, for example, in truck or trailer superstructures, unloaded, and separated into a transport sequence. The packages are then scanned in the transport sequence, wherein a sorting parameter is recorded according to which the packages are sorted. Depending on the sorting parameter, the packages are then distributed to different transport units, with which the packages are then transported away from the sorting station. In many cases, unlike the transport units that are unloaded at the sorting station, these transport units are roll containers, mesh boxes, pallets, pallets with walls, or unit load devices (ULDs). Unit load devices are pallets and containers that are used to load aircraft and are therefore adapted to the dimensions of aircraft fuselages. However, so-called swap bodies, i.e. truck bodies with supports for parking without a chassis and for driving under with a chassis for the purpose of loading, can also be used as transport units, both as transport units to be loaded and as transport units to be unloaded at the sorting station.

After scanning, the packages can be temporarily stored in an intermediate storage facility, such as a rack warehouse or similar, until they are transported further. The packages can then be removed from the intermediate storage facility in a specific or arbitrary order. However, in order to achieve high efficiency and a short dwell time for the packages in the sorting station, intermediate storage of the packages is often dispensed with. The packages are transported by conveyor belts or similar means from the unloading point to the loading point in other transport units and sorted in the process. It is conceivable, for example, that the packages are partially moved from one conveyor belt to another conveyor belt or into a chute in order to sort the packages. There is then a transport sequence, as required, in which the packages are transported, scanned, and fed into a sorting device. After sorting, the packages are typically loaded into different transport units, which is done by a robot as required.

In order to make efficient use of the space available in the transport units, the dimensions of the packages are also recorded in some cases. A loading algorithm can then specify where certain packages should be stacked in the transport units in order to minimize wasted space. The current loading status of the transport units can be monitored with sensors. If the packages are temporarily stored in the sorting station, they can be removed from the temporary storage in an order that allows them to be stacked in a space-saving manner.

Regardless of how the packages are sorted and how space-savingly or randomly the transport units are loaded with packages, it cannot be ruled out that individual packages may be damaged by other packages in the transport unit. The damage may only affect the packaging. However, this can still lead to damage to the packaged goods or to problems with the subsequent handling of the damaged package.

### SUMMARY OF THE INVENTION

Therefore, the present invention addresses the problem of designing and further developing the method of the type mentioned at the outset and explained in more detail above in such a way that damage to packages as a result of loading the packages into a transport unit is avoided.

This problem is solved by a method described herein for loading at least one transport unit with packages,
in which the packages are scanned one after another with an optical scanner,
in which at least one stability parameter for each package is determined based on the images captured by the optical scanner by an evaluation unit,
in which the evaluation unit assigns a stability score to each package based on the at least one stability parameter, and
in which the packages are loaded into different locations in the at least one transport unit depending on the respective stability score.

When loading at least one transport unit, the packages are scanned using an optical scanner before the transport unit is loaded with the packages. The optical scanner thus produces image material or the like, which can be evaluated relatively easily and quickly with an evaluation unit. The evaluation unit is designed to determine at least one stability parameter of the package based on at least one image of the respective package. The stability parameter helps to determine how stable the respective package is, which can be expressed roughly or approximately by a stability score that is derived by the evaluation unit based on the stability parameter and assigned to the respective package. If only one stability parameter is determined by the evaluation unit, the stability parameter can correspond to the stability score. However, the stability score may also depend on at least one other factor in addition to the single stability parameter. This may be at least one other stability parameter and/or at least one other parameter that does not necessarily have anything to do with a stability parameter. Procedurally, the stability score of the packages determines where the packages should be loaded into the transport unit in order to avoid damage to the loaded packages.

However, the packages do not necessarily have to be loaded at different locations in the at least one transport unit solely based on their respective stability scores. Other parameters that have nothing or little to do with the stability of the packages can also be taken into account. For example, in addition to the stability scores, the dimensions of the packages and/or their weight can also be taken into account. The dimensions can be easily scanned. The weight can be read by the scanner or determined with a scale, if indicated on the package. For example, the weight can be determined with the scanner based on the type of package, a label, or postage. In this way, the cargo space in transport units can be better utilized and it can be further prevented that particularly heavy packages damage packages located below them.

To avoid damage to an individual package with a high degree of certainty, the package can be loaded at the very top of the transport unit so that no other packages are stacked on top of it. However, this does not rule out the possibility that packages loaded at the very top of the transport unit may damage a package below or contribute to its damage. Furthermore, it goes without saying that not all packages can be loaded at the top of a transport unit if the cargo space has to be used efficiently.

It therefore makes sense to load the more stable packages lower down in the transport unit than the packages that are more easily damaged and therefore less load-bearing. If the packages are sufficiently load-bearing at every point in the transport unit to support the other packages loaded above them, individual packages loaded in a transport unit are very unlikely to be damaged. The load-bearing capacity of the packages can be represented by the stability score in such a way that a higher stability score indicates higher stability, load-bearing capacity, and/or stackability, and a lower stability score indicates lower stability, load-bearing capacity, and/or stackability. The value range of the stability score can be specified as required. The value range of the stability score can, for example, be between 0 and 1. A stability score of 0 could then indicate minimal or at least essentially no stability, load-bearing capacity, and/or stackability, while a stability score of 1 could indicate maximum, i.e. very high stability, load-bearing capacity, and/or stackability.

In order to determine the at least one stability parameter of a package as accurately as possible, it may be advisable to take several different images of the package with the optical scanner. This is particularly useful if the images are taken from different angles and/or if different sides, or all sides of the respective package, are scanned as required. Independently or in addition to this, it may also be advisable to scan different details of the packages that have a significant influence on the at least one stability parameter to be determined. However, if the images have sufficient resolution, special attention can also be paid to certain details of the package without scanning this detail separately. It may therefore be sufficient if the relevant detail is captured with sufficient accuracy in a larger image.

In order to assign a stability score to the packages that characterizes the load-bearing capacity and stability of the packages as reliably as possible and that is also as relevant as possible for the practical loading of the packages into the transport unit, in many cases it will be appropriate for the evaluation unit to determine several different stability parameters from the images transmitted by the optical scanner, which then jointly determine at least part of the stability score to be assigned to the packages. For example, at least one stability parameter may depend on the type and/or size of the package, while at least one other stability parameter may depend on the type of packaging material or damage to the packaging material or the package. The stability score can then take into account all these parameters and factors influencing stability, load-bearing capacity, and/or stackability, as well as their interaction, in a characteristic value.

For the purpose of ensuring the best possible comparability of different packages, in particular those to be loaded in a common transport unit, it may be advisable to determine the same at least one stability parameter for each of the respective packages. In the case of several different stability parameters, these stability parameters can be determined for each of the packages to be examined.

Packages can generally be understood to mean general cargo of various types. However, they can also refer to general cargo of a special type, such as goods packed in packaging. Packages can therefore have at least one outer packaging made of paper, cardboard, fabric, or plastic and can be, for example, parcels, boxes, and containers, as well as non-rigid containers such as bags, pouches, or sacks. The goods packed in packages can themselves be individual piece goods, bulk goods, liquids, or pasty materials.

In a first particularly preferred embodiment of the method, the packages are loaded at different height levels in the at least one transport unit depending on their respective stability scores. It is therefore not absolutely necessary to establish a clear sequence of the packages according to their stability scores, according to which the loading of a transport unit is carried out in a mandatory and precisely predefined manner, even though this is of course possible. In principle, it is sufficient to classify the possible stability scores and assign the corresponding classes of stability scores to height levels in the at least one transport unit. In many cases, for example, it may be useful to classify the stability scores into three different classes, wherein the packages with stability scores in the highest class are loaded into the transport unit at the lowest height level. The packages with stability scores corresponding to the middle class are then loaded onto the transport unit at a middle height level. Finally, the packages with stability scores in the lowest category are loaded onto the top height level. For the sake of simplicity, the number of different height levels and the number of different stability score classes are therefore the same. The example described above also offers the advantage that the order in which the packages are loaded is not determined solely by the stability score of the packages. When determining the order in which the packages are loaded, other parameters such as the size of the respective packages, the weight of the respective packages, and the loading condition of the corresponding transport unit can also be taken into account. For example, a high packing density with little free space in the transport unit can be achieved. In addition, excessive stress on packages due to other particularly heavy packages can be avoided.

In the example described above, stability scores between 0 and 0.33 can be assigned to a lower class of stability scores, while stability scores between 0.34 and 0.66 correspond to a middle class of stability scores and stability scores between 0.67 and 1 correspond to an upper class of stability scores. All packages with a stability score between 0.67 and 1 are therefore loaded into the transport unit first and at the lower height level. The packages with a stability score between 0.34 and 0.66 are then loaded into the transport unit at the middle height level of the transport unit. Finally, the packages with stability scores between 0 and 0.33 are loaded into the transport unit at the upper height level of the transport unit. It goes without saying that the assignment of height levels and stability scores depending on the respective transport units is coordinated in such a way that the packages with corresponding stability scores can be loaded onto the assigned height levels without being damaged by packages loaded later.

However, this does not take into account how many packages of what size and/or weight have stability scores in which category. It is conceivable, for example, that there are no or hardly any packages with stability scores between 0.67 and 1. It is also conceivable that there are too many particularly heavy packages, especially those with a low stability score, for them to be loaded appropriately without being damaged themselves or damaging other packages. The value limits for assigning the stability score to the different categories may need to be adjusted so that packages are not damaged by packages stacked higher up in the transport unit.

Therefore, it may also be provided that packages with a stability score of a certain category are loaded into the transport unit at the height level assigned to that category or at a higher height level. If, for example, a package has sufficient stability, load-bearing capacity, and/or stackability to be loaded at a medium height level, this is all the more sufficient for it to be loaded at a higher height level. This increases the probability that packages will be loaded at a height level at which they can be loaded without damage due to their stability score. However, this may in turn be limited by the size and/or weight of the packages.

The advantages of the invention mentioned above are particularly evident when the at least one transport unit is a roll container, a mesh box, a pallet, a pallet with walls, a so-called swap body, a truck, or a unit load device (ULD). Such transport units are very often used to redistribute packages. In addition, such transport units are very often used for packages which, due to their low stability, load-bearing capacity, and/or stackability, can sometimes be easily damaged if loaded improperly.

Alternatively or additionally, it is advisable if the packages are scanned by a six-sided scanner oduring lo a line scanner, in particular an RGB line scanner, and/or a volume scanner. A six-sided scanner can preferably take one image from each of the six sides of the package, wherein the pixels of the images can then be evaluated. In particular, gray values in certain areas of the package can be used to draw conclusions about the order of magnitude of corresponding stability parameters. For example, the pixels belonging to a package can be counted and the dimensions of the package can be determined from this, especially if calibration has been performed beforehand with regard to the ratio of pixel numbers and dimensions.

In simpler cases, a line scanner can also be used, with the packages transported past it. The line scanner scans one side of the package, for example from above, and takes images line by line. The pixels of each line can then be plotted against time or the number of lines in succession, resulting in images from a plurality of individual lines and thus ultimately pixel areas that correlate with the scanned areas of the packages.

RGB scanners are particularly preferred in this context, wherein RGB refers to a color space formed by the colors red, green, and blue, i.e. the primary colors of light. Put simply, the line scanner captures the colors red, green, and blue. In contrast to line scanners, six-sided scanners allow the three-dimensional shape of the package to be determined.

If necessary, so-called volume scanners, which usually use lasers, can also be used as an alternative or in addition. Volume scanners can also be designed as line scanners, over which the packages are then transported. The advantage of these scanners is that the three-dimensional shape of the packages can be determined from a point cloud of the laser captured by a corresponding detector. Typically, the side of a package resting on a conveyor belt is not scanned, but this can usually be accepted. In most cases, the packages are scanned by the laser from one side, in particular at least essentially from above.

In order for the evaluation unit to be able to determine the at least one stability parameter for each package very reliably and accurately, it may be advantageous to use several scanners applying different principles instead of a single scanner. In this way, the evaluation unit can be provided with a particularly suitable and comprehensive database for determining the stability parameters.

For efficient and error-free loading of the packages into the at least one transport unit, it may be provided that the packages are loaded by at least one robot into different locations in the at least one transport unit, at least partially depending on the respective stability scores. However, if a person is used for loading instead of at least one robot, it cannot be ruled out that this person may occasionally accidentally place packages at inappropriate height levels in the transport unit. However, people often have a good intuitive sense of where on a height level which packages should be stacked appropriately in order to avoid damage to the packages and, if necessary, to make efficient use of the loading space, even if the packages have stability scores in the same category or if the packages have at least essentially the same stability scores.

In order to ensure that packages can be loaded into the at least one transport unit quickly and reliably, it is advantageous if the robot and/or the person is shown and/or informed of information regarding the stability score of the respective package. In the case of a robot, the relevant information can be transferred to the robot via a suitable interface. The information can also be noted on the package itself, in particular for the person, for example by means of a colored sticker or a colored marking on the package, wherein certain colors then represent certain stability scores or stability score ranges. The robot can then detect and evaluate the display as required by means of appropriate sensor technology.

In the case of a person, the relevant information can be communicated acoustically, for example via headphones. Alternatively or additionally, the information can also be displayed, wherein the information is noted on the package, for example, by means of a colored adhesive sticker or another color code, or is displayed on a display in such a way that the person can easily, quickly, and reliably assign the displayed information to the respective package. If necessary, information regarding the location of loading determined based on the stability score can also be displayed and/or communicated in addition to or as an alternative to the information regarding the stability score of the respective package. The manner of display and communication can be carried out as before for the information regarding the stability score, if necessary.

The effectiveness of the present method can be increased if the packages are scanned one after another in a transport sequence using the optical scanner. In this case, the packages can be passed one after another in the transport sequence in front of the optical scanner. Depending on the stability scores assigned to the packages, the packages can then be arranged into a loading sequence that differs from the transport order, in which the packages are loaded into the transport unit one after another. This procedure can be automated to a high degree and thus accelerated. For smooth loading of the packages, it is also advisable to transport the packages in the loading sequence to the robot loading the packages into the transport unit and/or to the person loading the packages into the transport unit.

If necessary, the packages are automatically sorted by a sorting device according to the stability scores assigned to them, resulting in a loading sequence that differs from the transport sequence. The corresponding degree of automation generally increases the overall efficiency of the process. In addition, packages can be removed from the transport sequence and/or loading sequence as non-stackable based on the assigned stability score. These non-stackable packages can then be handled separately, in particular manually and/or loaded into special transport units. As a result of the non-stackable packages being removed, they do not interfere with the loading of the at least one transport unit with the other, stackable packages. A further increase in efficiency can be achieved, if necessary, when the packages are automatically transported by a transport device in the loading sequence to the robot loading the packages into the transport unit and/or to the person loading the packages into the transport unit. The packages then only need to be picked up in the appropriate loading sequence and stacked in the transport unit.

Preferably, the evaluation unit can determine at least one stability parameter of the packages in form of a size parameter, in particular in form of a height, a width, and/or a length. This is possible by evaluating the optical scans in a known manner. In addition, corresponding size parameters influence the stability, load-bearing capacity, and/or stackability of the packages. Typically, smaller packages are more stable and load-bearing and are therefore easier to stack. Packages of similar volume are generally more stable and load-bearing if they are cube-shaped, for example. Long and flat packages, on the other hand, are less preferred from a stackability point of view.

In addition to or as an alternative to the dimensions, the evaluation unit can determine at least one stability parameter of the packages relating to their shape and/or surface. In this way, too, conclusions can be drawn about the stability, load-bearing capacity, and/or stackability of the packages.

At least one stability parameter can be assigned as an alternative or in addition to a package type determined by the evaluation unit and/or a packaging material of the package determined by the evaluation unit and/or a multi-layered structure of the determined packaging material determined by the evaluation unit and/or a coating of the packaging material determined by the evaluation unit and/or a moisture content of the packaging material determined by the evaluation unit and/or at least one stain on the packaging material determined by the evaluation unit. The type of package and/or the packaging material can be determined, for example, from the shape of the package and its surface. The multi-layered structure of a cardboard box, for example, can also be deduced from the shape of the package or from an imprint. In the case of packages comprising a cardboard box, the box is usually single-layered, double-layered, or triple-layered. The more layers there are, the more stable the package is in principle. Any coating provided can also have a positive influence on the stability of the package. On the other hand, moisture in the packaging material typically leads to reduced stability of the package. This applies even if the packaging material has dried again. The evaluation unit can, if necessary, detect a stain where the packaging material is or was damp. However, spots can also be indications of other impairments to the packaging material that reduce the stability of the package.

The at least one stability parameter can also be linked to the detection of a logo, a sticker, a return address, and/or a return label. Logos can provide information about the sender or the type of package. If a logo of a particular online retailer known for a certain quality of packaging is recognized, a stability parameter can be assigned to the logo. Stickers and/or a return address can also provide information about the sender and the type of package, which, based on experience, is associated with a certain type or quality of package. A stability parameter can then be assigned to the sticker and/or return address. Return labels typically indicate a package created by a private individual. Experience shows, for example, that returns are usually sent in the same packaging, which tends to have reduced stability after being opened and resealed. Return labels are therefore more likely to indicate a poorer stability score.

Alternatively or additionally, the at least one stability parameter may be assigned to the type of adhesive tape applied to the package and/or the arrangement of adhesive tape applied to the package and/or the size of the opening area of the package and/or the arrangement of the opening area of the package on the package and/or the degree of opening of the opening area of the package. The adhesive tapes can be used to determine whether they have been applied professionally and/or by machine or whether they have been applied by a private individual. The latter is usually an indication of a reduced stability score. Since opening areas of packaging usually weaken the packaging, the size of the respective opening area of the package can be used as a stability parameter. The smaller the opening area, the better in terms of increased stability of the packages. This is all the more true if the degree of opening of the opening area is low. In this case, the opening area is largely closed with adhesive tape or other means and is therefore only slightly open at most.

The at least one stability parameter can alternatively or additionally also be assigned to at least one degree of damage to the package, wherein the at least one degree of damage is assigned to the shape of the edges of the package and/or the shape of the corners of the package and/or the shape of the seams of the package and/or the shape of the surface between the edges, corners, and/or seams of the package. The less sharp-edged and straight the shape of the edges and corners is, the less stable the package is likely to be. If the shape of the seams varies considerably along the longitudinal direction of the seams, this may indicate that the seams are damaged in some areas. Between the seams, corners, and edges, the surface of the package may be very uniform or rather uneven. The latter would tend to indicate a weakening of the package and thus a poorer stability parameter.

The at least one stability parameter can also be assigned to the shape of the surface, wherein any scrapings, dents, creases, tears, and/or cuts detected on the surface of the package should lead to less favorable stability parameters. The condition and defects of a package can be used to determine a reuse index. The basic principle here is that the stability, load-bearing capacity, and stackability of packaging deteriorate the more often it is reused. A reuse index can therefore be assigned to a stability parameter. It may also be useful for the evaluation unit to assign at least one stability parameter to a relative position of the package relative to the shape of the package. This is because packages can have different levels of stability in different orientations. This can be taken into account using the aforementioned stability parameter. This circumstance can also be exploited in such a way that the evaluation unit assigns a direction-dependent stability score to each package based on the at least one stability parameter. The stability score is then higher or lower depending on the orientation in which the corresponding package is placed in the at least one transport unit. For example, the package may have a longitudinal direction and two transverse directions that are independent of each other and therefore perpendicular to each other, with a separate stability score being assigned to each of these directions.

If, for example, the stability score in a transverse direction is particularly high, the package can preferably be loaded into the transport unit in such a way that this transverse direction at least essentially coincides with the vertical. This then also allows loading at a lower height level than if the package were stacked in the transport unit in a different orientation. Consequently, different direction-dependent loading scenarios may be considered for direction-dependent stability scores of packages. The loading scenario to be considered in each case can then be selected based on external circumstances, such as the loading condition of the transport unit, the type of transport unit, the stability scores of the other packages, the sizes of the other packages, and/or the weight of the packages.

Consequently, in the case of a direction-dependent stability score, the package can be loaded into the at least one transport unit in a specific orientation in a direction-dependent manner based on the respective direction-dependent stability scores. For this purpose, information concerning the direction-dependent stability score and/or information concerning the orientation of the package can, for example, be displayed and/or communicated to the robot and/or person during loading into the transport device. In this case of displaying and/or communicating, the displaying and/or communicating can also be carried out as described above. In addition, it may be provided that the robot and/or the person decides, based on which of the direction-dependent stability scores of a package, where and in which orientation the package is loaded into the transport unit.

In order to assign the at least one stability parameter to the packages as accurately as possible, it may be advantageous for the evaluation unit to determine at least one stability parameter using an automated pattern recognition unit based on artificial intelligence. The evaluation unit makes use of the conclusions drawn from a plurality of previous packages that have been examined with regard to the stability parameter. The evaluation unit can thus take into account recurring patterns with recurring influences on the stability score. This applies in particular if the packages examined in the past were scanned with the same or a similar scanner as the packages whose stability parameters are to be estimated based on past examinations.

The evaluation unit can therefore rely primarily on empirical values without actually calculating the stability parameters from specific measured values, although this may still be the case, for example when determining the stability parameter relating to the dimensions of the packages. This also takes into account the fact that in many cases the stability score cannot be calculated, or at least not with reasonable effort, based on certain parameters of the package, and certainly not with satisfactory accuracy.

It is only known how to calculate stacking compression resistance from the dimensions of the packages and the packaging material used. In the applications relevant here, however, there is usually no precise information available on the packaging materials of individual packages. But even if the stacking compression resistance can only be estimated, it can be used to supplement the determination of the stability score of the packages, for example in the form of a base value, which is then adjusted with reductions and/or additions according to the stability score, depending on whether the stability parameters indicate an improvement or deterioration in stability, stackability, and/or load-bearing capacity compared to the initial value.

It therefore makes sense for the automated pattern recognition unit to be trained using a plurality of images of packages and stability information, stability parameters, and/or stability scores respectively associated with these packages in order to determine stability parameters based on the images of packages used for training and stability information, stability parameters, and/or stability scores respectively associated with these packages. In principle, this is a typical empirical approach in connection with the use of artificial intelligence. Therefore, no further detailed explanations are required for the person skilled in the art.

Regardless of the determination of the stability parameters, it is advantageous to determine and use the stability score if it is calculated mathematically based on at least one stability parameter.

In a particularly preferred case, this can be done by ensuring that the at least one stability parameter always has a value in the range between 0 and 1. A value of 1 can then mean that the stability, load-bearing capacity, and stackability of the package are not impaired by the determined stability parameter, for example in comparison to a package-specific initial value. A value of 0, on the other hand, would mean that, as a result of the determined stability parameters, no significant stability, load-bearing capacity, and stackability can be assumed. The package can then be classified as “non-stackable,” so that this package can, for example, be sorted out and loaded separately.

For simplicity, the stability parameters used to calculate the stability score can be multiplied together. This gives a stability score in a range between 0 and 1, as required. A stability score of 1 indicates no reduced stackability, for example, compared to a specific initial value, while a value of 0 indicates that the package is not stackable. Multiplying the stability parameters has the advantage that even a single stability parameter with a value of 0, independent of the other stability parameters, results in a stability score of 0. In addition, several low values of several stability parameters result in a very low stability score. As a result, the stability score can be used to a high degree of effectiveness for loading packages into a transport unit.

This is all the more true when real, randomly damaged packages and their actual stability parameters are used to train the pattern recognition unit. The stability scores then represent particularly practical values. In order to be able to use clearly defined packages for training, it is advisable to use specifically damaged packages and their actual stability parameters to train the pattern recognition unit. Depending on the application, real or specifically manipulated packages can be used to train the pattern recognition unit. However, the best training results are often achieved when training is carried out using real packages and specifically manipulated packages. In principle, however, it will be necessary to define and also measure or at least estimate the values of the stability parameters.

### BRIEF DESCRIPTION OF THE DRAWINGS

The terms Fig., Figs., Figure, and Figures are used interchangeably in the specification to refer to the corresponding figures in the drawings.

The invention is explained in more detail below with reference to a drawing that merely illustrates exemplary embodiments. The drawing shows in

FIG. 1 a sorting station for carrying out a first embodiment of the invention in a schematic view,

FIG. 2 a method according to the invention for loading transport units with packages in a schematic representation, and

FIG. 3 an alternative method according to the invention for loading transport units with packages in a schematic representation.

### DESCRIPTION OF THE INVENTION

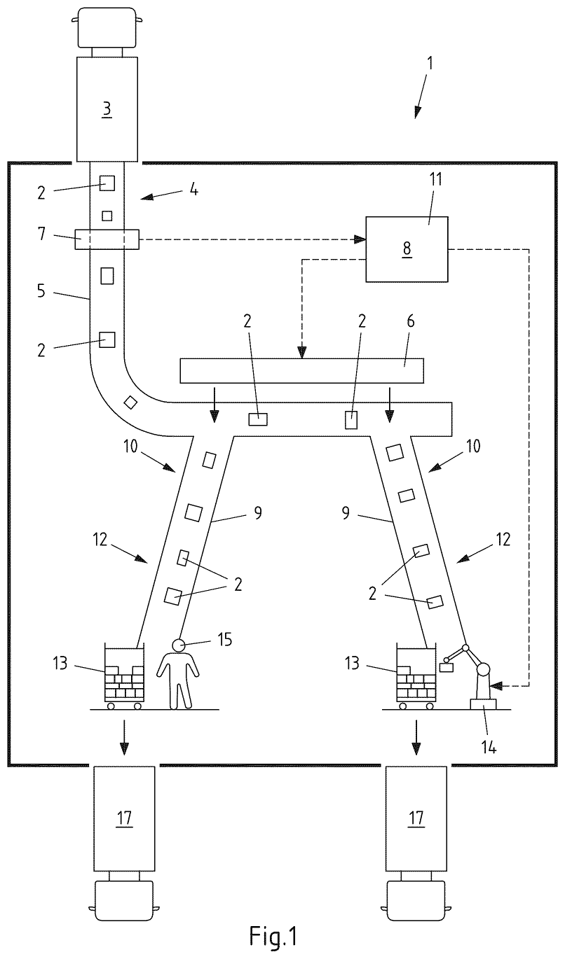

FIG. 1 shows a sorting station 1 for redistributing packages 2. The packages 2 can be general cargo, parcels, envelopes, bags, and/or sacks. The packages 2 are transported to the sorting station 1 using transport units 3 in the form of commercial vehicles, in particular trucks, trailers, and/or semi-trailers, with the packages 2 located in the superstructures of the commercial vehicles. Upon arrival at the sorting station 1, the packages 2 are unloaded and separated. In the method shown and preferred in this respect, a single transport sequence 4 of packages 2 is generated from the unloaded packages 2. The transport sequence 4 is transported, in particular at least essentially continuously, by at least one conveyor belt 5 through the sorting station 1 to a sorting device 6. If necessary, several transport sequences 4 can also be generated, which can then be handled in parallel in the sorting station 1.

The transport sequence 4 of the packages 2 is fed to an optical scanner 7, in which a sorting parameter, in particular a postal code, is recorded for each package 2. In addition, the weight of the packages 2 can be recorded. In the method shown and preferred in this respect, the packages 2 are transported through a six-sided scanner 7, wherein the packages 2 are scanned on all six sides. Target information such as a postal code is read out, which is relevant as a sorting parameter for the subsequent sorting of the packages 2. The order of the packages 2 and the sorting parameters assigned to the packages 2 are transmitted to a control device 8. The packages 2 are transported from the scanner 7 to the sorting device 6, where the packages 2 are sorted according to the sorting parameter. The sorted packages 2 are stacked by chutes 9, conveyor belts, or other receptacles by a person or by a robot 14 into the transport units 13 provided for this purpose.

With regard to the packages 2, the described method is suitable if the packages 2 are repackaged piece goods, in particular piece goods repackaged in cardboard boxes. It is particularly useful if the piece goods are parcels, bags, envelopes, pouches, and/or bags. These packages 2 are to be sorted and distributed in large numbers and with a short dwell time in sorting stations.

The images generated by the scanner 7 are also fed to an evaluation unit 11, which is located in the control device 8 in the sorting station shown and preferred in this respect, but does not have to be. The evaluation unit 11 determines a plurality of stability parameters for each package 2 based on the images from the scanner 7. These stability parameters can take values between 0 and 1. A value of 1 is assigned if the evaluation of the images from the scanner 7 results in maximum stability with regard to the type of the respective stability parameter. A value of 0 is assigned if minimum stability can be assumed with regard to the corresponding type of stability parameter. In other words, the lower the stability parameter, the greater the compromises that must be made in terms of the stability, stackability, and/or load-bearing capacity of the package 2. A stability parameter value of zero may mean that the associated package 2 is not stackable and must therefore be sorted out, which is not shown here but can be done in various ways.

A value relating to the stability, stackability, and/or load-bearing capacity of the package 2, which is derived at least essentially from the dimensions and/or the packaging material used, can be used as a starting value from which corresponding compromises in the stability, stackability, and/or load-bearing capacity of package 2 can be made. However, other starting values are also conceivable. For example, the specific load-bearing capacity, in particular the stacking compression resistance, of a package 2 can be calculated from the geometric dimensions of a package 2 and a specific stability of the packaging material used, in particular the edge compression resistance, which can be used as a starting value. For example, the value of the specific stability can be in the range between 18 kN/m and 55 kN/m. However, depending on the stability parameters of the corresponding package 2, reductions from this initial value must then be taken into account.

A load-bearing capacity in the form of stacking compression resistance can be calculated as follows, for example:

$$BCT = 5.876 * ECT * \sqrt{PU * VMD}$$

$$BCT = stack compression resistance [ kN ]$$

$$ECT = edge compression resistance [ kN / m ]$$

$$PU = Package circumference [ mm ]$$

$$VMD = Packaging material thickness [ mm ]$$

The higher the stacking compression resistance, the greater the stability, load-bearing capacity, and/or stackability of the package 2. The package circumference can be determined by the evaluation unit 11 using the images captured by the scanner 7. The packaging material thickness can be estimated from the images of the packages 2 captured by the scanner 7.

The stacking compression resistance determined in this way can now be used as a starting value and multiplied by the stability parameters determined by the evaluation unit in order to take into account possible reductions in stability, stackability, and/or load-bearing capacity. These may result, for example, from damage to the packages 2, in particular to the packaging. For example, certain areas of the package 2 may be dented or scraped. The edges or corners of the package 2 may also be bent or otherwise damaged. It is also possible that the packaging of the package 2 has not been sealed properly or has been used several times before. All of these can be parameters that contribute to reduced stacking compression resistance. To avoid unnecessary repetition, reference is also made to the stability parameters already explained in the general description. The theoretical stacking compression resistance, calculated as previously indicated and multiplied by the values determined for the stability parameters, then forms the stability score as required:

$$S C = BCT * S P 1 * S P 2 * … * S P N$$

$$S C = stability score$$

$$BCT = stacking compression resistance$$

$$S P 1 = stability parameter 1$$

$$S P 2 = stability parameter 2$$

$$…$$

$$S P N = Stability parameter N$$

$$N = Number of different stability parameters$$

In a simpler case, the stability score can also be determined simply by multiplying the individual stability parameters determined by the evaluation unit.

$$S C = S P 1 * S P 2 * … * S P N$$

$$N = Number of different stability parameters$$

The stability score is then dimensionless as required and can take on a value between 0 and 1 as required.

Regardless of how the stability score is determined, the packages 2 are stacked in the transport units 13 depending on the stability scores of the packages 2, for example in such a way that packages with similar stability scores are grouped together. In this way, a loading sequence 12 of the packages 2 is generated. In other words, the stability scores of adjacent packages 2 are therefore similar, while the stability scores of packages 2 between packages 2 between which many other packages 2 are arranged may differ significantly from one another. The packages 2 are generally grouped from a high stability score value towards a lower stability score value, i.e. in the direction of decreasing stability scores. The stability score is preferably determined in the evaluation unit 11 or the control device 8.

For the sake of simplicity, the packages 2 do not have to be arranged in the loading sequence 12 exactly in the order specified by the stability scores. Otherwise, the effort required for regrouping may be too great. In addition, it is usually not a problem if, for example, a package 2 with a higher or lower stability score than the other two packages 2 is placed between two packages 2. Nevertheless, the advantage is achieved that in loading sequence 12, the packages 2 with high stability, stackability, and/or load-bearing capacity are first placed in a transport unit 13, and only then are packages 2 with increasingly lower stability scores loaded into the transport unit 13.

The particularly stable packages 2 are then arranged at the bottom of the transport unit 13, but are not damaged by the packages 2 stacked above them. Less stable packages 2 are arranged further up in the transport unit 13, at a height such that they are also not damaged by packages 2 arranged above them. The least stable packages 2 are then placed at the very top of the transport unit 13.

A loading sequence 12 that is not strictly based on stability scores also allows the size of the packages 2 and/or the weights of the packages 2 to be taken into account. The loading sequence 12 then not only protects the packages 2 in the transport unit 13, but also ensures that the transport unit 13 is loaded in a space-saving manner.

The packages 2 can be loaded into the transport units 13 by a robot 14 and/or by a person 15, as required, in the loading sequence. However, it is also conceivable that the robot 14 and/or the person 15 can select which package 2 is to be loaded next. This will then typically be a package 2 that can be loaded in a space-saving manner and that has a stability score appropriate for the corresponding height level. The stability score assigned to the respective package 2 can be displayed or communicated to the robot 14 and/or to the person 15. In this case, it is possible to dispense with regrouping the packages 2 from the sorting sequence 10 into a loading sequence 12, either in whole or in part.

It is also possible to dispense with regrouping the packages 2 from the sorting sequence 10 into a loading sequence 12 if the sorting device 6 does not sort the packages 2 solely according to the at least one sorting parameter. In this case, the packages 2 can be sorted on the one hand according to the sorting parameter and on the other hand according to the dimensions and/or stability scores of the packages 2. The sorting device 6 thus generates packages 2 in sorting sequences 10, which also represent loading sequences 12. The packages 2 can therefore be loaded into the transport units 13 in sequence, wherein the prior sorting ensures that the packages 2 can be loaded in a space-saving manner and do not damage each other.

In the sorting station 1 shown and preferred in this respect, the loaded transport units 13 are loaded into commercial vehicles 17, in particular trucks or trailers, and transported away. This is not necessary. The transport units 13 could also be handled in other ways after loading.

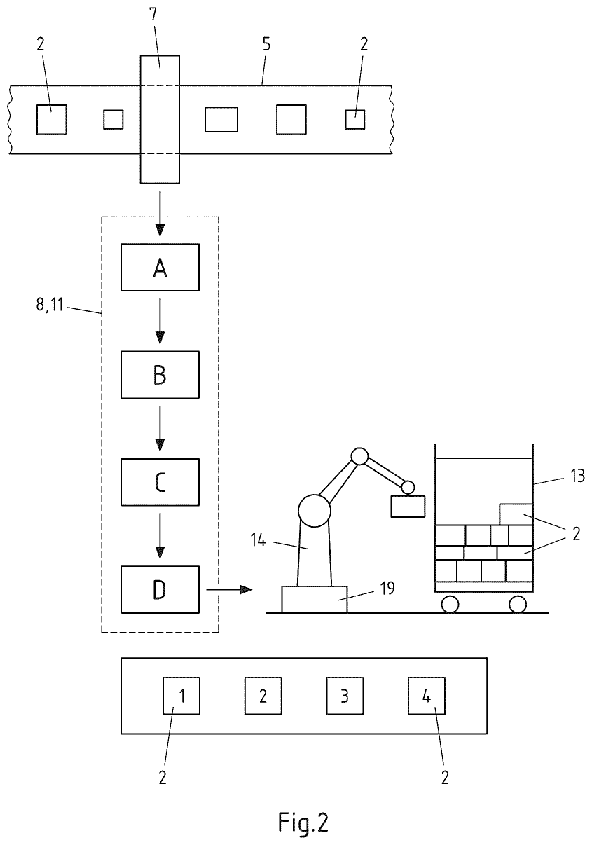

FIG. 2 schematically shows a possible method for loading transport units 13 with packages 2. In a first method step, the packages 2 are passed on a conveyor belt 5 past a scanner 7, which may be, for example, a six-sided scanner. However, other types of scanners are also conceivable. The images generated by the scanner 7 are forwarded to an evaluation unit 11, which may or may not be integrated into a control device 8 of a sorting station 1. In a first processing step A, the evaluation unit 11 uses the images from the scanner 7 to determine a plurality of stability parameters for each package 2, based on which the evaluation unit 11 determines a stability score for each package 2. In addition, the dimensions of the packages 2 are determined by the evaluation unit 11 using the data transmitted by the scanner 7.

Then, in a subsequent step B, the evaluation unit 11 or the control device 8 calculates an arrangement of the packages 2 in a transport unit 13 after loading based on the dimensions and stability scores of the packages 2. This arrangement is optimized mathematically so that the space available in the transport unit 13 is used as efficiently as possible by the packages 2, thus saving space. In other words, the aim is to determine the densest possible packing of the packages 2 in the transport unit 13 without unnecessarily large voids. At the same time, the stability scores of the packages 2 should be taken into account when calculating the arrangement of the packages 2 in the transport unit 13, so that the packages 2 in the transport unit 13 are not damaged by the other packages 2 in the calculated arrangement. Due to the latter requirement in particular, compromises may have to be made in terms of the utilization of the cargo space of the transport units 13. If an attempt were made to load the transport units 13 in the most space-saving way possible, it might be necessary to load packages 2 with low stability scores far down in the transport unit 13, where the corresponding packages 2 would be highly likely to be damaged, in particular crushed, by packages 2 stacked above them.

If an arrangement of packages 2 has been determined in which, on the one hand, the space available for loading in the transport unit 13 is well utilized and, on the other hand, damage to the packages 2 is highly likely to be avoided, the evaluation unit 11 or the control device 8 calculates, in a third processing step C, a loading sequence for packages 2 in which the packages 2 are to be stacked in the transport unit 13 in order to produce the calculated arrangement of packages 2 in the transport unit 13. In a fourth processing step D, this loading sequence is communicated together with the previously calculated, optimized arrangement of the packages 2 to a robot 14, which picks up the packages 2 in the loading sequence and stacks them in the corresponding arrangement in the transport unit 13.

This is illustrated in FIG. 2 by the numbering of the packages 2. However, physical numbering or other separate marking of the packages 2 is not necessary. The robot 14 only needs to be able to distinguish the packages 2 and assign them to the loading sequence. The robot 14 can actively recognize parameters of the packages 2 for this purpose. Alternatively or additionally, the robot 14 can also be informed of the position of each package 2, in particular its orientation. The robot 14 is controlled by its own control system 19 so that it loads the packages 2 into the transport unit 13 in the desired sequence and arrangement.

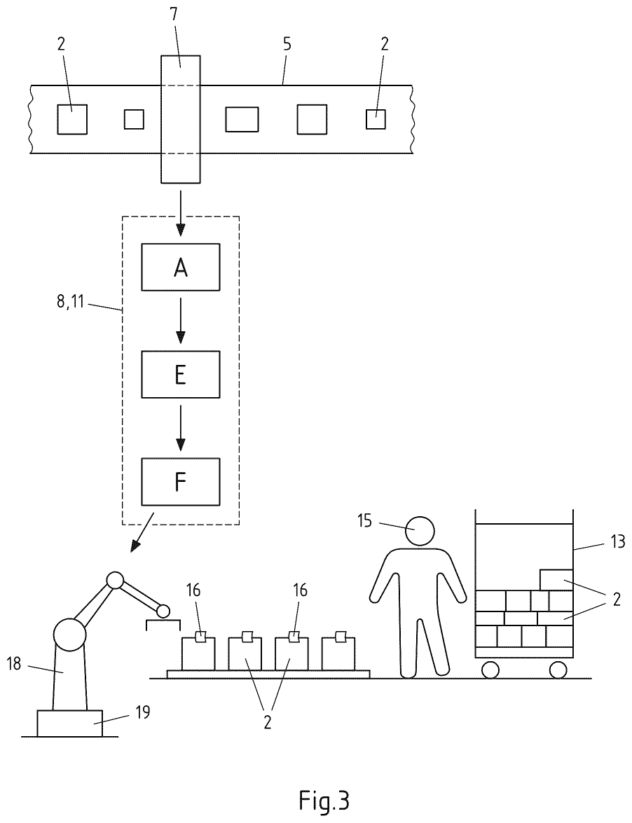

FIG. 3 schematically shows an alternative method for loading transport units 13 with packages 2. The first two steps of the method, namely scanning the packages 2 and determining the dimensions and stability scores of the packages 2, are carried out as in the method shown in FIG. 2. However, no optimized arrangement of the packages 2 in the transport unit 13 is calculated. Instead, the packages 2 are provided with labels 16, which represent certain value ranges of the stability score and are generated in a subsequent processing step E. These value ranges can, for example, be associated with the stability properties “not stackable,” “low stability,” “normal stability,” and “very stable.” In a simple case, the labels 16 can have different colors, wherein the colors are assigned to the different value ranges or stability properties in the sense of a color code. The packages 2 are then loaded manually into the transport unit 13 by a person 15, wherein the person 15 takes into account the loading status of the transport unit 13, the size of the packages 2, and their stability scores based on the labels 16.

In the method shown and preferred in this respect, a robot 18 passes the packages 2 to the person 15 for loading into the transport unit 13, wherein the robot 18 first applies the labels 16 to the packages 2. It may be provided that the robot 18 performs a pre-sorting of the packages 2 based on the dimensions and stability scores of the packages 2, so that the person 15 always has a suitable selection available for loading the next packages 2. However, this is not necessary. The appropriate control routine for the robot is created in a processing step F prior to loading.

Instead of a label 16, information concerning the stability score can be projected to the person 15 loading the packages 2 onto the packages 2 provided for loading and selection by the person 15 using a laser or other light source. This information can be, for example, the stability score or a range of values for the stability score. Alternatively, it is also conceivable that the person 15 in question wears headphones and the information concerning the stability score of the packages 2 is transmitted to the person 15 as an audio signal. However, person 15 may also wear virtual reality glasses so that the information concerning the stability score is displayed to person 15 visually in the form of virtual reality. For example, the packages 2 may be color-coded by the virtual reality glasses depending on the respective stability score of the packages 2.

### LIST OF REFERENCE SIGNS

1 Sorting station
2 Package
3 Transport unit
4 Transport sequence
5 Conveyor belt
6 Sorting device
7 Scanner
8 Control device
9 Conveyor belt
10 Sorting sequence
11 Evaluation unit
12 Loading sequence
13 Transport unit
14 Robot
15 Person
16 Label
17 Commercial vehicle
18 Robot
19 Control system

1. A method for loading at least one transport unit with packages,
in which the packages are scanned one after another with an optical scanner,
in which at least one stability parameter is determined for each package based on the images captured by the optical scanner by an evaluation unit,
in which the evaluation unit assigns a stability score to each package based on the at least one stability parameter, and
in which the packages are loaded at different locations in the at least one transport unit depending on the respective stability scores.

2. The method according to claim 1,
in which the packages are loaded at different height levels in the at least one transport unit depending on the respective stability scores, and
in which, preferably, the packages are loaded at least at the different height levels high, medium, and low in the at least one transport unit depending on the respective stability scores.

3. The method according to claim 1,
in which the at least one transport unit is a roll container, a mesh box, a pallet, a pallet with walls, a so-called swap body, truck, or unit load device (ULD), and/or
in which the packages are scanned by a six-sided scanner and/or by a line scanner, in particular an RGB line scanner, and/or a volume scanner.

4. The method according to claim 1,
in which the packages are loaded by at least one robot and/or by at least one person into different locations in the at least one transport unit depending on the respective stability scores, and
in which, preferably, the robot and/or the person is shown and/or informed of information concerning the stability score and/or information concerning the loading location determined based on the stability score.

5. The method according to claim 1,
in which the packages are scanned one after another in a transport sequence with the optical scanner,
in which the packages are arranged into a loading sequence that differs from the transport sequence depending on the stability scores assigned to the packages and are loaded into the transport unit in the loading sequence, and
in which, preferably, the packages are transported in the loading sequence to the robot loading the packages into the transport unit and/or to the person loading the packages into the transport unit.

6. The method according to claim 5,
in which the packages are automatically arranged by a sorting device in a loading sequence that differs from the transport sequence depending on the stability scores assigned to the packages and/or
in which packages are removed from the transport sequence and/or the loading sequence as non-stackable based on the assigned stability score, and/or
in which the packages are automatically transported by a transport device in the loading sequence to the robot loading the packages into the transport unit and/or to the person loading the packages into the transport unit.

7. The method according to claim 1,
in which at least one stability parameter of the packages is determined by the evaluation unit in form of a size parameter, in particular in form of a height, a width, and/or a length, and/or
in which at least one stability parameter of the packages relating to the shape and/or the surface is determined by the evaluation unit.

8. The method according to claim 7,
in which the at least one stability parameter is assigned to a determined package type and/or a determined packaging material of the package and/or a multi-layered structure of the determined packaging material and/or a coating of the packaging material and/or a moisture content of the packaging material and/or at least one stain on the packaging material, and/or
in which the stability parameter is assigned to a logo, a sticker, a return address, and/or a return label.

9. The method according to claim 7,
in which the at least one stability parameter is associated with the type of adhesive tapes affixed to the package and/or the arrangement of adhesive tapes affixed to the package and/or the size of the opening area of the package and/or the arrangement of the opening area of the package on the package and/or the degree of opening of the opening area of the package.

10. The method according to claim 7,
in which the at least one stability parameter is assigned to at least one degree of damage to the package and
in which, preferably, the at least one degree of damage is assigned to the shape of the edges of the package and/or the shape of the corners of the package and/or the shape of the seams of the package and/or the shape of the surface between the edges, corners, and/or seams of the package.

11. The method according to claim 10,
in which the at least one stability parameter is associated with the shape of the surface, scrapes, dents, creases, cracks, and/or cuts on the surface of the package and/or
in which the at least one stability parameter is associated with a reuse characteristic value of the package.

12. The method according to claim 7,
in which the evaluation unit assigns at least one stability parameter to a relative position of the package relative to the shape of the package and
in which, preferably, the evaluation unit assigns a direction-dependent stability score to each package based on the at least one stability parameter.

13. The method according to claim 12,
in which the packages are loaded in a specific orientation in the at least one transport unit depending on the respective direction-dependent stability scores, and
in which, preferably, information concerning the direction-dependent stability score and/or information concerning the orientation of the package is displayed and/or communicated to the robot and/or to the person at the transport unit.

14. The method according to claim 1,
in which the evaluation unit determines at least one stability parameter using an automated pattern recognition unit by means of artificial intelligence, and
in which, preferably, the automated pattern recognition unit has been trained using a plurality of images of packages and stability information, stability parameters and/or stability scores respectively associated with these packages in order to determine stability parameters based on the images of packages used for training and stability information, stability parameters and/or stability scores respectively associated with these packages.

15. The method according to claim 1,
in which the stability score is calculated based on the at least one stability parameter,
in which, preferably, the at least one stability parameter has a value in the range between 0 and 1,
in which, further preferably, the stability parameters are multiplied with one another to calculate the stability score, and
in which, in particular, the stability score has a value in the range between 0 and 1.

16. The method according to claim 14,
in which real, randomly damaged packages and their actual stability parameters and/or deliberately damaged packages and their actual stability parameters are used to train the pattern recognition unit.
